(19) United States
(12) Patent Application Publication
(10) Pub. No.: US 2022/0050872 A1
(43) Pub. Date: Feb. 17, 2022

(54) Device, System, and Method of Generating and Playing Navigatable Podcasts

(71) Applicant: AudioCodes Ltd., Lod (IL)

(72) Inventors: Shabtai Adlersberg, Ra'anana (IL); Menachem Honig, Metar (IL); Felix Flomen, Savyon (IL)

(21) Appl. No.: 16/994,599

(22) Filed: Aug. 16, 2020

(51) Int. Cl. G06F 16/683; G06F 16/64; G06F 16/638; G10L 15/26; G06F 3/16

(52) U.S. Cl. CPC G06F 16/685; G06F 16/64; G06F 3/165; G10L 15/26; G06F 16/638

(57) ABSTRACT

Devices, systems, and methods of generating and playing navigatable podcasts. A method includes: receiving an audio recording of a podcast; performing automatic speech recognition of the audio recording of the podcast, to generate a textual transcript of the podcast; detecting vocal cues in the textual transcript of the podcast, wherein each detected vocal cue indicates a beginning of a new in-podcast topic of the podcast; automatically generating for the podcast a table of content having a list of in-podcast topics. An end-user device then displays the table of content of the podcast during its playback, and enables to skip or navigate among the displayed in-podcast topics.

### FIELD

The present invention is related to the field of Information Technology.

### BACKGROUND

Millions of people utilize mobile and non-mobile electronic devices, such as smartphones, tablets, laptop computers and desktop computers, in order to perform various activities. Such activities may include, for example, browsing the Internet, sending and receiving electronic mail (email) messages, taking photographs and videos, engaging in a video conference or a chat session, playing games, or the like.

### SUMMARY

The present invention may include, for example, systems, devices, and methods for automatic generation of a podcast, as well as other types of audio recordings, audio presentations, streaming audio, or other audio content; such that the generated audio content is user-friendly and is efficiently and easily navigatable (can be navigated) by a user, e.g., by an end-user listener or consumer of the audio content.

For example, a method includes: receiving an audio recording of a podcast; performing automatic speech recognition of the audio recording of the podcast, to generate a textual transcript of the podcast; detecting vocal cues in the textual transcript of the podcast, wherein each detected vocal cue indicates a beginning of a new in-podcast topic of the podcast; automatically generating for the podcast a table of content having a list of in-podcast topics. An end-user device then displays the table of content of the podcast during its playback, and enables to skip or navigate among the displayed in-podcast topics.

The present invention may provide other and/or additional benefits or advantages.

### BRIEF DESCRIPTION OF THE DRAWINGS

FIG. 1 is a schematic block-diagram illustration of a system, in accordance with some demonstrative embodiments of the present invention.

### DETAILED DESCRIPTION OF SOME DEMONSTRATIVE EMBODIMENTS

The term “podcast” as used herein may include, for example, a web-based or Internet-based podcast, a streaming or stream-able podcast, a downloaded or download-able podcast, an audio file or an audio stream, an audio-based presentation or content, or other types of audio content, which may be streamed or downloaded or subscribed to or otherwise accessed, particularly via the Internet or via an HTTP or HTTPS communication link or via an Internet Protocol (IP) network; and including a podcast or an audio content that is broadcasted or multi-casted or distributed or sent or delivered or presented, in real time or in non-real-time, to a single user or to a plurality of users or to an audience of users, using a one-to-many distribution system or a client/server system or a peer-to-peer network or other suitable architectures.

The Applicants have realized that many users listen to podcasts or consume podcasts, in various topics or subjects, from various types of end-user devices, e.g., a smartphone, a tablet, a laptop computer, a desktop computer, a vehicular multimedia system or entertainment system, or other electronic devices.

The Applicants have realized that a podcast may be long, such as, may include audio of 60 minutes, and that some users may not have the time or the patience to listen to a podcast in its entirety, from its beginning to its end.

The Applicants have realized that some users may wish to selectively listen to only particular portions or segments of a podcast, yet they are unable to do so efficiently or easily or accurately. For example, the Applicants have realized that a typical podcast is identified only by its Title, such as, “An Introduction to Physics”, and possibly several other descriptors, such as “Author/Narrator: John Smith”, and “Time Length: 58 minutes”, and possibly “Suitable for Teenagers” or other general tags or descriptors. However, such basic descriptors of the entire podcast do not assist the user in selectively listening to only specific portions of the podcast.

The Applicants have realized that some users may utilize a brief textual description which may accompany the podcast, in order to “guess” how far within the podcast they need to “skip” or “fast forward” in order to attempt to reach an audio segment that is more interesting to them to consume. For example, the above-mentioned podcast with a lecture of “Introduction to Physics”, may be accompanied by a brief textual summary that mentions that “In this lecture, we will describe the works of Galileo, Newton, Einstein, Feynman, and Hawking”. A user may therefore “guess” that the audio segment that relates to Einstein, might possibly appear at approximately the middle of the podcast; and thus, the user may try to skip forward to approximately 29 minutes from the beginning of the podcast. However, such guess often yields non-accurate and non-satisfying results, since topics within the podcast are not allocated exactly equal time-slots; and since it is non-trivial for some users to compute how to guess at which time-point a certain topic is estimated to begin.

The Applicants have realized that even the inclusion of a full textual transcript, along the audio podcast, does not efficiently mitigate the problems described above. Firstly, many users do not have the time or the patience to read or to review a lengthy textual podcast, that corresponds to a one-hour audio lecture, and which can often span many pages of text and thousands of words. Secondly, some users may perform a textual search, such as searching for the word “Einstein” in the textual transcript of the podcast; however, names or keywords are often mentioned in various locations along the podcast and its transcript, and not necessarily only in the main segment that relates to the searched word; thereby misleading the user and causing him to listen to audio segments that mention a desired keyword (based on his search through the transcript) but not actually describing his topic of interest. For example, a user may review the transcript of the above-mentioned example lecture, and may search for the word “Einstein”; and may find the word “Einstein” appearing three times in the sentence “Newton has preceded Einstein by two centuries, and has lived in Europe just like Einstein, and has contributed to physics as much as Einstein did”; and may thus try to “skip” the audio recording towards that sentence, as it indeed mentions “Einstein” three times; however, that audio segment actually describes Newton and not Einstein, and the user's attempt to find the more relevant audio segment has thus failed.

The Applicants have realized that this problem might be partially mitigated if a human author of the podcast would make a manual effort, to add a longer textual description that accompanies the podcast, which can mention, for example: “In this podcast, we will discuss Galileo at time point 02:17, and will then discuss Newton at time-point 08:39, and will then discuss Einstein at time-point 16:47”, and so forth. Such a manually-prepared summary may assist some end-users to better navigate within the audio podcast. However, realized the Applicants, the manual preparation of such “table of contents” for a podcast is time consuming an effort consuming on the side of the podcast author or narrator; and can also suffer from inaccuracies on his side, and requires him to invest time and efforts to manually create such “table of content” and then to publish it as an accompanying text. Furthermore, realized the Applicants, such accompanying text is not always read or even seen by some users, who do not pay attention to it. Additionally, even an accompanying textual description of “Einstein at time-point 16:47”, is not user-friendly, and still requires the end-user to “blindly” skip forward or to “guess” with multiple clicks until he reaches that particular time-point.

The Applicants have also realized that some podcast are authored or narrated in a manner which is not necessarily linear or chronological; for example, the podcast author may relate to a certain topic in various different portions of his podcast, or may go back to a previously-discussed topic, or may start by providing several examples and may then provide a more detailed explanation about each topic by not necessarily in their original order. Therefore, realized the Applicants, the task of understanding the actual structure of a podcast, and the topics discussed in it and their exact order and their in-podcast distribution, is a challenging task for many end-users, and is also time consuming, effort consuming, and is prone to errors; which in turns leads to increased frustration by users, and/or to users “aborting” and leaving the podcast entirely due to their failure to easily and rapidly find the audio segment that is of greater interest to them.

The Applicants have thus realized that in conventional podcast generation systems, there is no efficient automated mechanism to automatically generate a table-of-contents for an audio podcast, or a set of bookmarks or milestones or time-points of interest within the podcast.

The Applicants have also realized that in conventional podcast playback systems, there is no efficient mechanism to enable the end-user who consumes and listens to the podcast, to efficiently navigate within the audio podcast and to easily and immediately and accurately access a particular audio segment that is of interest to him.

The present invention includes methods and systems for automated or semi-automated generation and creation of a “table of contents” for a podcast, in a manner that is easy, rapid, efficient and user-friendly to the author or narrator or the person who creates the podcast. For example, the podcast creator says or utters particular Vocal Cues or Vocal Commands, during his narration or creation of the podcast, that indicate that a particular topic or portion or segment is now beginning; and the system monitors and identifies such Vocal Cues, and uses their time-points, to then automatically generate and utilize a table-of-contents for the podcast.

For example, the podcast creator in the above-example of “Introduction to Physics” audio lecture, says “Let's discuss now Newton” when he wants the system to automatically create an in-podcast bookmark or a podcast table-of-contents item for the topic of “Newton”; and then later, he may say “Let's discuss now Einstein” when he wants the system to automatically create an in-podcast bookmark or a podcast table-of-contents item for the topic of “Einstein”; and so forth, for each Topic or Audio Segment that he wants to mark in his podcast. The system is configured to monitor the speech uttered by the podcast creator during the podcast recording session, to perform speech-to-text conversion or other Speech Recognition (SR) process, and to identify and extract the Vocal Cues of “Let's Discuss Now” which are configured to mark a new topic. Therefore, even though the podcast creator may mention the term “Einstein” in various different portions of his podcast, he would say only and exactly one time the phrase “Let's Discuss Now Einstein” at a particular time-point in which he wants the system to set an in-podcast bookmark for the topic of “Einstein”. The system extracts the first word, or the K words (e.g., the first three words) that are recognized immediately after the triggering vocal cue of “Let's Discuss Now”, and may use those word(s) as the Topic itself; or, the system may extract the words that follow the vocal cue until a silence or a pause of at least T seconds is recognized (e.g., all the words that follow the vocal cue, until a silence of a narration pause of at least 1.5 seconds is detected).

The system thus utilizes Vocal Cues detection, or Key Phrases detection, in order to determine that a particular time-point in the audio content is designated by the audio creator as an Item in a table-of-content (or a list-of-topics) that the system should construct automatically; and the particular time-point in which the Key Phrase or the Vocal Cue is uttered (e.g., the time-point in which it begins to be uttered) is marked by the system as the time-point in which this new topic begins. The system enables a creator of a podcast to naturally and efficiently “flag”, via his vocal cues, the particular portions or segments or topics in this audio podcast; and each such vocal cue or vocal “flag” causes the system to detect the Topic that is flagged and the Time-Point in which that topic begins.

In some embodiments, the Vocal Cue is implemented only a Beginning Marker vocal cue; such that the system recognizes the vocal cue, and uses it to mark the beginning of a new topic or segment, and uses the several few words that follow the vocal cue for the extraction of the description of the topic itself. In other embodiments, optionally, the Vocal Cue has a beginning cue and an ending cue, which the narrator wraps around the description of the topic; for example, the podcast creator says, “Let's discuss now Albert Einstein, starting right now”, and may say “Let's discuss now Stephen Hawking, starting right now”; and the system may be configured such that the commencing vocal cue of “Let's discuss now” is utilized by the system as a commencing cue that indicates that a new topic begins now, and that the description of that particular topic is the phrase that is said between “Let's discuss now” and “starting right now”; thereby enabling the system to automatically generate table-of-content items that are labeled “Albert Einstein” and “Stephen Hawking” in the above example.

The system may thus construct, automatically or semi-automatically based on the Vocal Cues uttered by the podcast creator, a Table of Contents or a List of Topics for the created podcast. In some embodiments, the automatically generated Table of Contents may be displayed or presented as a textual or graphical or other visual representation, on the screen of the electronic device that is utilized for playback and consumption of the audio podcast. An end-user may click or tap or select a particular Topic from the Table of Content; and in response to such user selection, the playback application or the playback device may automatically skip or fast-forward or rewind or navigate to the Time Point that corresponds to this user-selected Topic, such that the audio playback will now resume exactly from the Time Point of that user-selected Topic.

The end-user may utilize his playback device or application to Search and to find a particular topic that is of interest to him, especially in long podcast which may have numerous topics; while knowing that the searched topic will appear only once or exactly once in such automatically generated Table of Contents or List of Topics. Therefore, even though the audio podcast about “Introduction to Physics” may mention “Einstein” many times, the system generates only one single Topic (or table-of-content item) that is “Einstein”, thereby allowing an end-user to efficiently search and find the single appearance of this Topic in the list of topics.

In some embodiments, the system may also warn the audio creator, that two (or more) of the Topics that he triggered via his Vocal Cues have the same name or a sufficiently-similar name, which may cause confusion to some listeners or end-users. For example, the podcast creator may say, “Let's discuss now Albert Einstein”; and a few minutes later, he may say “Let's discuss now Albert Einstein's Theory of Relativity”. The system may automatically detect that these two topics have overlapping keyword(s), or a portion that appears in both of the topics; and the system may notify the podcast creator that these two topics may cause some confusion to some listeners, or may make it more difficult for some listeners to search for the topic of “Einstein” since such search would yield two topic results. The system may allow the podcast creator to review such warning notifications, and to manually modify one (or some, or all) of the topic descriptors that the system generated based on vocal cues.

Furthermore, the system may be utilized by a podcast distribution system, or by a streaming audio distribution service (e.g., YouTube, Pandora, Spotify, or the like), thereby enabling rapid and efficient and accurate creation of table of content for numerous podcasts, and enabling the user of such platform to perform Cross-Podcast Searches. For example, a user of a conventional platform that hosts or serves podcast, was limited to searching only for “all podcasts that mention Einstein in their Title”, or “all podcasts that mention Einstein in their Brief Textual Description”, or “all podcasts that mention Einstein in their Full Transcript”. In contrast, the system of the present invention, when utilized in conjunction with multiple different podcasts that different authors have contributed to a unified podcast distribution platform, enable an end-user to perform more robust searches; such as, “show me all the podcasts that have Einstein as an in-podcast Topic”, or “show me all the podcasts that have an in-podcast Audio Segment that is named Einstein and that is at least 5 minutes long”; thereby providing new search and find capabilities to users, and increasing the ability of a podcast distribution platform to match among users and podcasts of interest.

Furthermore, the system of the present invention may enable an end-user to subscribe, or to request real-time alerts or daily or weekly alerts, with regard to any new podcast that contains particular in-podcast Topic (e.g., “Einstein”), optionally also defining various other user-requested restrictions or filtering parameters; such as, only in a particular language, or only podcasts that have a minimum time-length and/or a maximum time-length, or only podcasts in which the requested in-podcast Topic occupies a particular time-segment (e.g., not less than 2 minutes, and not more than 8 minutes), or the like.

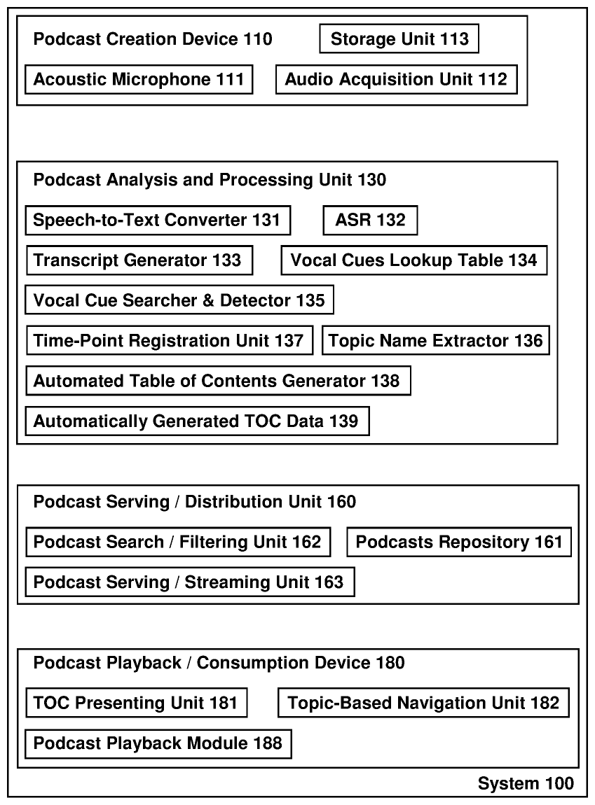

Reference is made to FIG. 1, which is a schematic block-diagram illustration of a system 100, in accordance with some demonstrative embodiments of the present invention. System 100 may comprise, for example: (I) a Podcast Creation Device 110, which may be used by user such as a podcast author or a podcast narrator to record and create a podcast; (II) a Podcast Analysis and Processing Unit 130, which takes the raw podcast that was recorded, performs analysis and processing operations, and generates or constructs and adds a Table of Contents or a List of Topics or a List of In-Podcast Bookmarks to the podcast; (III) a Podcast Serving/Distribution Unit 160, to serve or distribute the processed podcast to one or more end-users who listen to the podcast or consume its audio content via one or more electronic devices; and (IV) a Podcast Playback/Consumption Device 180, which is utilized by an end-user to listen to the podcast and to navigate through it based on the automatically generated Table of Contents.

Podcast Creation Device 110 may be or may comprise, for example, an electronic device or a computing device able to capture or acquire or record audio that is uttered or said by a podcast author or a podcast narrator. For example, Podcast Creation Device 110 may be implemented as a laptop computer, a desktop computer, a smartphone, a tablet, or other suitable electronic device. Such device may be equipped with an Acoustic Microphone 111 able to acquire sound or audio, controlled by an Audio Acquisition Unit 112 or audio acquisition program or audio recording program. For example, the Audio Acquisition Unit 112 may be implemented as a podcast recording program, which has on-screen UI elements or GUI elements that enable the podcast creator to start and stop and pause the recording of audio; to save or store the recorded audio; to set or modify a Title or a file-name of a recorded audio; to export or transmit or upload the recorded audio to another device or to a podcast storage and distribution platform; or the like.

The podcast creator utilizes the Audio Acquisition Unit 112 to “start” recording of a podcast, and the Podcast Creation Device 110 stores in a local Storage Unit 113 the audio acquired mWAV file, an MP3 file, an AAC file, a FLAC file, an AIFF file, an M4A file, or the like.

The digitally stored audio recording of the podcast may then be uploaded, sent or transmitted to the Podcast Analysis and Processing Unit 130. In some embodiments, the Podcast Analysis and Processing Unit 130 may be external to the Podcast Creation Device 110 and/or remote from the Podcast Creation Device 110, and such uploading or transmission of the podcast file may be performed over an IP-based communication link or over the Internet or using one or more wireless communication networks. In other embodiments, optionally, the Podcast Analysis and Processing Unit 130 may be internal to the Podcast Creation Device 110, or may be co-located within or near the Podcast Creation Device 110, in order to enable local or co-located processing of the recorded podcast prior to transfer of a processed podcast (which includes also the automatically generated Table of Contents) to the Podcast Serving/Distribution Unit 160. In still other embodiments, the Podcast Analysis and Processing Unit 130 may be implemented as part of the Podcast Serving/Distribution Unit 160, or may be co-located with or within the Podcast Serving/Distribution Unit 160, or may be otherwise integrated within the Podcast Serving/Distribution Unit 160. Other suitable architectures may be used, and components or modules or elements of system 100 may be distributed in other ways among the various units or devices of system 100, instead of or in addition to the demonstrative arrangement that is depicted in the drawing.

Podcast Analysis and Processing Unit 130 receives the recorded podcast. There, a Speech-to-Text Converter 131 or an Automatic Speech Recognition (ASR) Unit 132 performs speech-to-text conversion or automatic speech recognition, passes the recognized speech to a Transcript Generator 133 which generates a textual transcript of the audio recording of the podcast. A Transcript Generator 133 generates and stores the textual transcript that was generated; and may also store time-points of time-based offsets that indicate the timing of each phrase or word or audio-portion in the recorded podcast. For example, the phrase “Good evening” in the transcript may be associated with a time-point of “00:03” (in the format of MM:SS, in this example), indicating that this phrase was uttered at 3 seconds from the beginning of the podcast; and the phrase “I hope that you enjoyed this lecture” may be associated with a time-point of “58:30” (in the format of MM:SS, in this example), indicating that this phrase was uttered 58.5 minutes from the beginning of the podcast.

In some embodiments, a Vocal Cues Lookup Table 134 (e.g., which may be implemented as a list, a table, an XML file, an Excel file, a spreadsheet, a database, a data-set, or the like) stores indicators or rules or representations of Vocal Cues or vocal commands or triggering phrases, that are utilized or supported by system 100, and further representing the result of identifying each such Vocal Cue. For example, in some embodiments, the Vocal Cues Lookup Table 134 may indicate that the vocal cue of “Let's discuss now” is utilized as a triggering phrase for a new Topic in a podcast. In other embodiments, the Vocal Cues Lookup Table 134 may indicate that each Topic is defined by a pair or nearby vocal cues, such as: “We will now discuss” and “starting here”, so that the system would identify the phrase of “We will now discuss Albert Einstein, starting here” as a triggering phrase to generate at that time-point a Topic named “Albert Einstein”, since these two words are between the first triggering cue (“We will now discuss”) and the second triggering cue (“starting here”).

In some embodiments, the entries in the Vocal Cues Lookup Table 134 may be user-configurable or user-modifiable; and optionally, multiple alternate vocal cues may be assigned for the same purpose (e.g., to identify a Topic within an audio podcast). For example, podcast creator Adam may decide that he wants the vocal cue for a new Topic to always be “Let's discuss now”; whereas, podcast creator Bob may decide that he wants any one of the phrases “Let's discuss now” or “We now discuss” or “Let's talk now about” to be alternate indicators for a new Topic in his podcast, in order to allow him to use different vocal cues to indicate the commencement of new topics, so that the resulting podcast would be more interesting and less repetitive.

Then, a Vocal Cue Searcher & Detector 135 searches for the one or more pre-defined Vocal Cues within the generated textual transcript of the recorded podcast. Once a Vocal Cue is detected, a Topic Name Extractor 136 extracts or determines the string of characters or the phrase that would be used as the Topic Name; such as, by extracting from the transcript the first M words that follow the vocal cue, or the words that follow the vocal cue until a pre-defined pause or silence of at least T milliseconds is detected, or based on other pre-defined topic extraction rules or criteria. A Time-Point Registration Unit 137 registers the exact time-point at which each identified Topic commences; such as, by registering the time-point or the time-offset, relative to the beginning of the audio recording of the entire podcast, at which the Vocal Cue was uttered. The process is repeated or performed for each one of the Vocal Cues that are detected in the podcast transcript; and an Automated Table of Contents Generator 138 generates the Table of Contents (TOC) which indicates the identified Topics (e.g., arranged in in their chronological order) and their respective Time-Points within the audio podcast.

The generated TOC data may be stored in one or more suitable formats and/or locations; for example, as meta-data within the audio file or accompanying the audio recording, or as a “sidecar” file (e.g., similarly to a subtitles file that may accompany a video recording), or as text or encoded text that may be appended to the end of the audio recording, or as a separate file or data-item which may be stored in a database and whose URL or URI or other resource locator or pointer may be stored within the meta-data of the audio file, or in other suitable ways that would later enable a podcast playback device or a podcast playback program to retrieve and utilize Automatically Generated TOC Data 139 in accordance with the present invention.

The audio recorded of the podcast, including or accompanied by the Automatically Generated TOC Data 139, are transferred or sent or uploaded from the Podcast Analysis and Processing Unit 130 to the Podcast Serving/Distribution Unit 160, which may add the received podcast (and its TOC data) to a Podcasts Repository 161. Optionally, a Podcast Search/Filtering Unit 162 receives from an end-user a search query, requesting a podcast whose title or meta-data meet particular conditions (e.g., the Podcast Title includes “Physics”; the podcast creation date is from the last 90 days; the podcast language is English; the podcast time-length is between 20 to 30 minutes; or the like), and retrieves from the repository one or more podcasts whose meta-data or properties match the requested query. Optionally, filtering and sorting operations may be performed on the search results of podcasts. In some embodiments, uniquely, the search that is performed in the Podcasts Repository 161 via the the Podcast Search/Filtering Unit 162 may include queries that pertain to an in-podcast Topic that was automatically generated by the system; for example, an end-user may request podcasts that have the above-mentioned criteria, and that also include at least one Topic that have “Einstein” in the topic name; or that have at least one topic that includes “Newton” in its name and wherein the Topic is not less than 3 minutes and not more than 8 minutes of the audio recording of the podcast. Therefore, the Podcast Search/Filtering Unit 162 may enable users to perform unique and novel searches within audio podcasts, based on automatically recognized Topics in podcasts, and based on properties of such identified Topics (e.g., minimum/maximum time length of topic; name of topic; percentage that the topic occupies relative to the entire podcast; or the like).

Upon selection by the end-user of a particular podcast, that podcast is served or streamed or otherwise transported by a Podcast Serving/Streaming Unit 163 to the user Podcast Playback/Consumption Device 180; either as an entire file, or as an ongoing stream of audio frames or audio segments or as a bitstream that carries audio data. The automatically generated TOC data 139 may also be transported to the Podcast Playback/Consumption Device 180, as an integrated portion of the audio recording (e.g., as meta-data), or as a “sidecar” or accompanying file or data-item; or by sending to the Podcast Playback/Consumption Device 180 a link or URL or URI or pointer to an online location from which the automatically generated TOC data 139 is then downloaded or retrieved by the Podcast Playback/Consumption Device 180.

At the Podcast Playback/Consumption Device 180, there is a Podcast Playback Module 188 or a Podcast Playback program having a UI or a GUI, which enables the podcast consuming user to start, stop and pause the audio playback of the podcast, and to perform other operations (e.g., to fast-forward or rewind, to increase or decrease the playback speed, or the like). Uniquely, a TOC Presenting Unit 181 may generate and display, on a screen of the Podcast Playback/Consumption Device 180, a representation of the automatically generated TOC of the podcast; for example, shown as a List of Topics or as a Table of Contents that is displayed near the GUI elements that control the playback of the podcast. Each item in the displayed TOC may be responsive, such that a click or tap or other type of user selection of a particular topic in the displayed TOC, triggers a signal to the Podcast Playback/Consumption Device 180 that the user wishes to skip or jump or navigate directly and immediately to the audio portion that corresponds to the user-selected topic. Accordingly, a Topic-Based Navigation Unit 182 identifies that the end-user has clicked (for example) on the third Topic in the displayed TOC; checks in the Automatically Generated TOC Data 139 and determines that this third topic commences at 14:30 (e.g., commences at 14.5 minutes into the audio recording of the entire podcast); and commands or triggers the Podcast Playback Module 188 to skip forward or backward in the audio recording to the time-point that corresponds to that topic, and to resume playback from that time-point onward. In some embodiments, optionally, the TOC Presenting Unit 181 may highlight or emphasize or otherwise mark the currently-playing Topic, in the list of topics that are displayed as the TOC of the podcast.

In some embodiments, optionally, the Podcast Playback/Consumption Device 180 and/or the Podcast Search/Filtering Unit 162 may operate to enable an end-user device, upon the request of its user, to playback, selectively, only particular topics from particular podcasts, based on user-defined criteria. For example, user Carl may utilize his Podcast Playback/Consumption Device 180 to retrieve all the audio podcasts that are in English, whose title includes the word “Physics”, and that include (in each podcast) at least one topic with the word “Einstein”, and to further instruct the Podcast Playback/Consumption Device 180 to playback only those topics (that include the word “Einstein” in the topic name) from all those podcasts, without playing the audio of other topics that precede or that follow those topics. Upon such request, the system proceeds to search and identify the podcasts that meet these criteria; and to send or transport the audio recordings of those podcasts to the Podcast Playback/Consumption Device 180; and the Podcast Playback/Consumption Device 180 proceeds on its side to selectively play, in each one of those podcasts, only the audio segments that meet the user-defined criteria (and not other segments of each audio podcast), one after the other; thereby enabling a user to efficiently consume a cross-podcast playback of selective topics from selected podcasts, in an automatic and continuous manner. In some embodiments, optionally, the Podcast Search/Filtering Unit 162 may operate in conjunction with the Podcast Serving/Streaming Unit 163, to extract or to cut or to trim only the audio segments of the particular topics that meet the user's criteria, and to transport only those audio segments to the Podcast Playback/Consumption Device 180; as discrete podcast portions, or (optionally) as an automatically merged or joined audio file that includes a “chain” of those audio portions that were extracted from multiple audio podcasts and that include only the selected Topic.

In some embodiments, the Podcast Playback/Consumption Device 180 may be utilized by the user in order to select a particular Topic for immediate navigation and playback; yet the actual navigation and skipping within the audio podcast may optionally be performed by (or via) the Podcast Serving/Streaming Unit 163 of the Podcast Serving/Distribution Unit 160, rather than by the Podcast Playback/Consumption Device 180 itself. For example, in some embodiments, user David listens to a podcast having an automatically generated TOC that includes seven Topics; and after two minutes, user David clicks on Topic #5 in the displayed TOC; and in response to that user selection, the Podcast Playback/Consumption Device 180 sends a signal to the Podcast Serving/Streaming Unit 163 of the Podcast Serving/Distribution Unit 160, the signal indicating a request to navigate or skip to the particular time-point that corresponds to Topic #5 in the TOC; and the Podcast Serving/Streaming Unit 163 of the Podcast Serving/Distribution Unit 160 stops serving the previously-served audio stream, and instead starts streaming to the Podcast Playback/Consumption Device 180 the audio stream commencing from the time-point which corresponds to Topic #5 according to the TOC.

In accordance with the present invention, each one of the devices or units of system 100 may be implemented by using (or may comprise) one or more hardware units and/or software units, processors, CPUs, DSPs, integrated circuits, memory units, storage units, wireless communication modems or transmitters or receivers or transceivers, cellular transceivers, a power source, input units, output units, Operating System (OS), drivers, applications, and/or other suitable components.

In some embodiments, a method comprises: (a) receiving an audio recording of a podcast; (b) performing automatic speech recognition of said audio recording of the podcast, to generate a textual transcript of said podcast; (c) detecting vocal cues in said textual transcript of the podcast, wherein each detected vocal cue indicates a beginning of a new in-podcast topic of said podcast; (d) automatically generating for said podcast a table of content having a list of in-podcast topics.

In some embodiments, step (d) comprises: generating for said podcast the table of content which comprises, for each topic, (i) a name of the in-podcast topic, and (ii) a time-point within the podcast in which said in-podcast topic begins.

In some embodiments, the method comprises: during playback of the audio recording of said podcast, receiving a user command to navigate to a particular in-podcast topic of said podcast; determining, based on said table of content, which time-point within the podcast corresponds to the in-podcast topic that said user selected; causing playback of the audio recording of said podcast to continue from said time-point onward.

In some embodiments, the method comprises: extracting the name of at least one in-podcast topic, from a textual phrase that immediately follows said vocal cue in the textual transcript of the podcast.

In some embodiments, the method comprises: extracting the name of at least one in-podcast topic, from a textual phrase (I) that immediately follows a first particular vocal cue in the textual transcript of the podcast, and (II) that ends by identifying a second particular vocal cue in the textual transcript of the podcast.

In some embodiments, the method comprises: extracting the name of at least one in-podcast topic, from a textual phrase (I) that immediately follows a first particular vocal cue in the textual transcript of the podcast, and (II) that includes words uttered until a pre-defined silence period is detected.

In some embodiments, the method comprises: determining a name and a time-point of an in-podcast topic based on detection of a triggering phrase that was uttered in the podcast and which matches one out of a plurality of pre-defined alternate vocal cues.

In some embodiments, the method comprises: determining a name and a time-point of an in-podcast topic based on detection of a triggering phrase that was uttered in the podcast and which matches one out of a plurality of pre-defined alternate vocal cues; wherein each of said pre-defined vocal cues, if detected in said textual transcript of the podcast, triggers a determination of a new in-podcast topic.

In some embodiments, the method comprises: determining a name and a time-point of an in-podcast topic based on detection of a triggering phrase that was uttered in the podcast and which matches one out of a plurality of pre-defined alternate vocal cues; wherein at least one of said pre-defined vocal cues is user-configurable and is uniquely set by a creator of said podcast as an alternate vocal cue for triggering detection determination of a new in-podcast topic.

In some embodiments, the method comprises: storing the table of content having the list of in-podcast topics as meta-data within said audio recording of said podcast.

In some embodiments, the method comprises: storing the table of content having the list of in-podcast topics as an accompanying file that accompanies said audio recording of said podcast.

In some embodiments, the method comprises: storing within a file of the audio recording of said podcast, a pointer to an online location that stores the table of content of the podcast.

In some embodiments, the method comprises: causing an electronic device, during playback of the audio recording of said podcast, to display a user-selectable on-screen representation of the table of content that was automatically generated for said podcast and which comprises said list of in-podcast topics.

In some embodiments, the method comprises: in response to a user selection of a particular in-podcast topic from said user-selectable on-screen representation of the table of content, causing the playback of the audio recording of said podcast to resume from a time-point that is pre-defined in said table of content as corresponding to said particular in-podcast topic.

In some embodiments, the method comprises: storing in a podcasts repository, a plurality of audio recordings of different podcasts, and further storing in said podcasts repository a representation of the table of content having the list of in-podcast topics that was generated for each podcast.

In some embodiments, the method comprises: storing in a podcasts repository, a plurality of audio recordings of different podcasts; storing in said podcasts repository, for each one of said different podcasts, a representation of the table of content having the list of in-podcast topics that was generated for each of said different podcast.

In some embodiments, the method comprises: in response to a user command, performing a search through said podcasts repository, and retrieving one or more particular podcasts that have an in-podcast topic which matches a user-defined query string.

In some embodiments, a system comprises: a hardware processor to execute code; and a memory unit to store code; wherein the hardware processor is configured: (a) to receive an audio recording of a podcast; (b) to perform automatic speech recognition of said audio recording of the podcast, to generate a textual transcript of said podcast; (c) to detect vocal cues in said textual transcript of the podcast, wherein each detected vocal cue indicates a beginning of a new in-podcast topic of said podcast; (d) to automatically generate for said podcast a table of content having a list of in-podcast topics; and to automatically generate, for each topic, (i) a name of the in-podcast topic, and (ii) a time-point within the podcast in which said in-podcast topic begins.

In some embodiments, the hardware processor is further configured: (e) during playback of the audio recording of said podcast, to receive a user command to navigate to a particular in-podcast topic of said podcast; (f) to determine, based on said table of content, which time-point within the podcast corresponds to the in-podcast topic that said user selected; (g) to cause playback of the audio recording of said podcast to continue from said time-point onward.

Some embodiments comprise a non-transitory storage medium or storage article having stored thereon instructions that, when executed by a hardware processor, cause the hardware processor to perform a method as described above and/or herein.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

The present invention may be implemented by using hardware units, software units, processors, CPUs, DSPs, integrated circuits, memory units, storage units, wireless communication modems or transmitters or receivers or transceivers, cellular transceivers, a power source, input units, output units, Operating System (OS), drivers, applications, and/or other suitable components.

The present invention may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

The present invention may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Embodiments of the present invention may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, an Augmented Reality (AR) device or headset or gear, a Virtual Reality (VR) device or headset or gear, a “kiosk” type device, a vending machine, an Automatic Teller Machine (ATM), a laptop computer, a desktop computer, a vehicular computer, a vehicular dashboard, a vehicular touch-screen, or the like.

The system(s) and/or device(s) of the present invention may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results, among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A method comprising:
(a) receiving an audio recording of a podcast;
(b) performing automatic speech recognition of said audio recording of the podcast, to generate a textual transcript of said podcast;
(c) detecting vocal cues in said textual transcript of the podcast, wherein each detected vocal cue indicates a beginning of a new in-podcast topic of said podcast;
(d) automatically generating for said podcast a table of content having a list of in-podcast topics.

2. The method of claim 1,
wherein step (d) comprises:
generating for said podcast the table of content which comprises, for each topic, (i) a name of the in-podcast topic, and (ii) a time-point within the podcast in which said in-podcast topic begins.

3. The method of claim 2, comprising:
during playback of the audio recording of said podcast, receiving a user command to navigate to a particular in-podcast topic of said podcast;
determining, based on said table of content, which time-point within the podcast corresponds to the in-podcast topic that said user selected;
causing playback of the audio recording of said podcast to continue from said time-point onward.

4. The method of claim 2, comprising:
extracting the name of at least one in-podcast topic, from a textual phrase that immediately follows said vocal cue in the textual transcript of the podcast.

5. The method of claim 2, comprising:
extracting the name of at least one in-podcast topic, from a textual phrase (I) that immediately follows a first particular vocal cue in the textual transcript of the podcast, and (II) that ends by identifying a second particular vocal cue in the textual transcript of the podcast.

6. The method of claim 2, comprising:
extracting the name of at least one in-podcast topic, from a textual phrase (I) that immediately follows a first particular vocal cue in the textual transcript of the podcast, and (II) that includes words uttered until a pre-defined silence period is detected.

7. The method of claim 2, comprising:
determining a name and a time-point of an in-podcast topic based on detection of a triggering phrase that was uttered in the podcast and which matches one out of a plurality of pre-defined alternate vocal cues.

8. The method of claim 2, comprising:
determining a name and a time-point of an in-podcast topic based on detection of a triggering phrase that was uttered in the podcast and which matches one out of a plurality of pre-defined alternate vocal cues; wherein each of said pre-defined vocal cues, if detected in said textual transcript of the podcast, triggers a determination of a new in-podcast topic.

9. The method of claim 2, comprising:
determining a name and a time-point of an in-podcast topic based on detection of a triggering phrase that was uttered in the podcast and which matches one out of a plurality of pre-defined alternate vocal cues; wherein at least one of said pre-defined vocal cues is user-configurable and is uniquely set by a creator of said podcast as an alternate vocal cue for triggering detection determination of a new in-podcast topic.

10. The method of claim 1, comprising:
storing the table of content having the list of in-podcast topics as meta-data within said audio recording of said podcast.

11. The method of claim 2, comprising:
storing the table of content having the list of in-podcast topics as an accompanying file that accompanies said audio recording of said podcast.

12. The method of claim 2, comprising:
storing within a file of the audio recording of said podcast, a pointer to an online location that stores the table of content of the podcast.

13. The method of claim 2, comprising:
causing an electronic device, during playback of the audio recording of said podcast, to display a user-selectable on-screen representation of the table of content that was automatically generated for said podcast and which comprises said list of in-podcast topics.

14. The method of claim 13, further comprising:
in response to a user selection of a particular in-podcast topic from said user-selectable on-screen representation of the table of content, causing the playback of the audio recording of said podcast to resume from a time-point that is pre-defined in said table of content as corresponding to said particular in-podcast topic.

15. The method of claim 2, comprising:
storing in a podcasts repository, a plurality of audio recordings of different podcasts, and further storing in said podcasts repository a representation of the table of content having the list of in-podcast topics that was generated for each podcast.

16. The method of claim 2, comprising:
storing in a podcasts repository, a plurality of audio recordings of different podcasts;
storing in said podcasts repository, for each one of said different podcasts, a representation of the table of content having the list of in-podcast topics that was generated for each of said different podcast.

17. The method of claim 16, further comprising:
in response to a user command, performing a search through said podcasts repository, and retrieving one or more particular podcasts that have an in-podcast topic which matches a user-defined query string.

18. A system comprising:
a hardware processor to execute code;
a memory unit to store code;
wherein the hardware processor is configured,
(a) to receive an audio recording of a podcast;
(b) to perform automatic speech recognition of said audio recording of the podcast, to generate a textual transcript of said podcast;
(c) to detect vocal cues in said textual transcript of the podcast, wherein each detected vocal cue indicates a beginning of a new in-podcast topic of said podcast;
(d) to automatically generate for said podcast a table of content having a list of in-podcast topics; and to automatically generate, for each topic, (i) a name of the in-podcast topic, and (ii) a time-point within the podcast in which said in-podcast topic begins.

19. The system of claim 18,
wherein the hardware processor is further configured
(e) during playback of the audio recording of said podcast, to receive a user command to navigate to a particular in-podcast topic of said podcast;
(f) to determine, based on said table of content, which time-point within the podcast corresponds to the in-podcast topic that said user selected;
(g) to cause playback of the audio recording of said podcast to continue from said time-point onward.

20. A non-transitory storage medium having stored thereon instructions that, when executed by a hardware processor, cause the hardware processor to perform a method comprising:
(a) receiving an audio recording of a podcast;
(b) performing automatic speech recognition of said audio recording of the podcast, to generate a textual transcript of said podcast;
(c) detecting vocal cues in said textual transcript of the podcast, wherein each detected vocal cue indicates a beginning of a new in-podcast topic of said podcast;
(d) automatically generating for said podcast a table of content having a list of in-podcast topics; and automatically generating for each topic (i) a name of the in-podcast topic, and (ii) a time-point within the podcast in which said in-podcast topic begins;
(e) during playback of the audio recording of said podcast, receiving a user command to navigate to a particular in-podcast topic of said podcast;
(f) determining, based on said table of content, which time-point within the podcast corresponds to the in-podcast topic that said user selected;
(g) causing playback of the audio recording of said podcast to continue from said time-point onward.
